(19) United States
(12) Patent Application Publication
(10) Pub. No.: US 2008/0049830 A1
(43) Pub. Date: Feb. 28, 2008

(54) Multiple Image Source Processing Apparatus and Method

(75) Inventor: Larry Richardson, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: DRIVECAM, INC., San Diego, CA (US)

(21) Appl. No.: 11/467,486

(22) Filed: Aug. 25, 2006

(51) Int. Cl. H04N 11/04

(52) U.S. Cl. 375/240.01

(57) ABSTRACT

Separate first and second input streams of image frames are received by a frame combiner module, which combines an image frame from the first stream with an image frame from the second stream to produce a single output stream of combined frames. The single output stream is encoded by an encoder module such as an MPEG encoder to produce an encoded output signal, which may be stored or transmitted over a network.

### BACKGROUND

1. Field of the Invention

The present invention relates generally to handling of video and other images, and is concerned with a method and apparatus for processing images from more than one source.

2. Related Art

Image and video compression is widely used in both transmission and storage of still and video images. This is because raw image or video data has a substantial bit rate, and it is difficult or impossible to transmit such a vast amount of information directly. Image and video compression techniques have therefore been developed for handling both still image and video data so as to reduce the amount of data for transmission or storage.

Some well known image and video compression standards include JPEG (Joint Photographic Experts Group) standards and MPEG (Moving Picture Experts Group) standards. There are three major MPEG standards: MPEG-1, MPEG-2 and MPEG-4. MPEG-4 is designed to transmit video and images over a narrower bandwidth than the prior standards, and can mix video with text, graphics, and 2-D and 3-D animation layers.

In order to transmit video signals using MPEG-4, an MPEG-4 encoder or codec (Coder-Decoder) is required. On the back end, a decoder codec decodes the compressed digital signal for playback. A standard MPEG-4 codec has only one channel, i.e. it supports only one stream or incoming video signal. If multiple video signals are to be transmitted, multiple MPEG encoders or codecs or multi-stream MPEG-4 codecs are required, which will be relatively expensive.

### SUMMARY

The present invention allows images or video from multiple sources, or multiple images or video signals from a single source, to be provided to a codec in a single stream.

According to one aspect of the present invention, an image processing apparatus is provided, which has a frame combiner module having at least two inputs for receiving images from two image sources and an output, the inputs comprising a first input for receiving a first input stream of image frames and a second input for receiving a second input stream of image frames. The frame combiner module is configured to combine each frame received at the first input with a frame received at the second input to produce a single output stream of combined image frames at the output. An image encoder is connected to the output of the frame combiner module for encoding the single output stream of image frames into an encoded signal. The encoded signal may be transmitted over a network.

The system may further comprise a corresponding decoder at the receiver end for receiving and decoding the encoded image stream and an image splitter for splitting each frame into two or more separate frames to substantially recreate the original separate streams of image frames.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of an image processing system and method according to an embodiment of the invention;

FIG. 2 is a more detailed block diagram of the image combiner and encoder at the transmitter end of the system of FIG. 1;

FIG. 3 is a more detailed block diagram of the image decoder and splitter at the receiver end of the system of FIG. 1;

FIG. 4 is a block diagram illustrating an exemplary wireless communication device which may be used in connection with the various embodiments described herein; and

FIG. 5 is a block diagram illustrating an example computer system that may be used in connection with the various embodiments herein.

### DETAILED DESCRIPTION

Certain embodiments as disclosed herein provide for a system and method for processing separate streams of image frames from a single source or from more than one source to provide a single stream of combined image frames. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

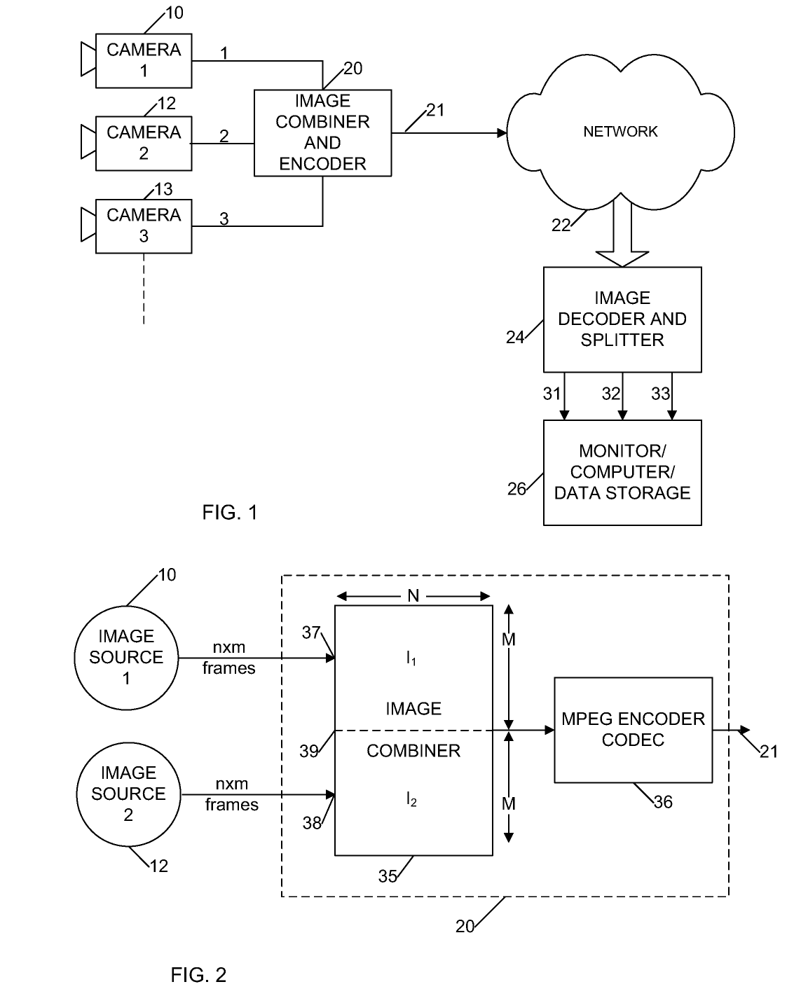

FIG. 1 is a block diagram illustrating a system and method according to an embodiment for combining images from more than one source into a single stream of images for transmission over a network to a receiver station, and for splitting the combined image stream into separate image streams at the receiver station. The network may be a wired or wireless network, or a combination wired and wireless network.

As illustrated in FIG. 1, separate image streams 1, 2, 3 . . . n from separate sources 10, 12, 13 . . . , which may be video cameras, still cameras or the like, are received at separate inputs of an image combiner and encoder unit 20, which is illustrated in more detail in FIG. 2. Although the image streams originate from three or more separate cameras in the illustrated embodiment, it will be understood that the same system may be used to combine images from only two separate sources, or different image streams from the same source or camera. The image combiner and encoder unit 20 is configured to combine the images from the separate image streams and produce a single combined image stream which is encoded or compressed to produce an encoded output 21 for transmission over a network to a receiver station. Alternatively, the encoded output 21 may be stored in a local data storage unit for later processing.

In the embodiment illustrated in FIG. 1, the encoded output stream 21 is transmitted over a network 22 to a selected receiver station having an image decoder and splitter unit 24 at which the encoded image stream is decoded and split up into separate image streams 31, 32, 33 which substantially correspond to the original input streams 1, 2, 3. These image streams are then sent to a processing or storage unit 26, which may have a monitor for viewing the separate image streams, a computer for further processing the image streams, and/or a data storage unit for storing the image streams. The encoded image stream could be stored on storage unit 26 to reduce storage requirements. Decoding and separating the image streams would then be done prior to viewing.

The receiver station may be a remote station to which the encoded image stream is transmitted for further processing, or may be a local station where the encoded image stream is simply stored until needed. The compressed single image stream will take up less storage space than the separate, uncompressed video or other image streams 1, 2, 3.

FIG. 2 illustrates the image combiner and encoder unit 20 of FIG. 1 in more detail. Unit 20 comprises an image combiner module 35 having two or more separate inputs 37, 38 and a single output 39, and a Moving Picture Experts Group (“MPEG”) encoder or codec module 36 connected to the output 39 of the image combiner module 35. In the illustrated embodiment, the images are video images and the encoder is an MPEG encoder such as an MPEG-4 encoder, but alternative image encoders may be used in other embodiments, such as MPEG-1 or MPEG-2, or a JPEG (Joint Photographic Experts Group) encoder if the images are photographic or still images. MPEG-4 is designed to transmit video and images over a narrower bandwidth than the prior standards, and can mix video with text, graphics, and 2-D and 3-D animation layers. Although combination of image frames from two separate image streams is illustrated in FIG. 2, it will be understood that more than two image streams may be combined in an equivalent manner in image combiner module 35 if required.

In FIG. 2, first and second image sources 10 and 12 provide first and second image streams. Each image stream comprises a series of frames each having a standard size of n×m. The video output streams are provided as separate inputs 37, 38 to the image combiner module 35, which combines each image frame of the first stream with an image frame of the second stream to produce a single combined image frame. In the illustrated embodiment, an image frame I₁ from the first stream is disposed on top of an image frame I₂ from the second stream, to produce a combined image frame I₁₊2 of size n×2m. This combining process is repeated for each frame of the first stream and second stream, so that a single output stream of combined images is produced at output 39.

The image frame from the first stream and the image frame from the second stream which are combined in module 35 may be synchronized in time, but this may not be essential and the image frames which are combined may be unsynchronized in other embodiments.

Although FIG. 2 illustrates image frames combined by disposing one image frame on top of another image frame, alternative techniques may be used for combining each pair of image frames in other embodiments, such as disposing them side-by-side or in other relative positions in the combined frame. Additionally, it will be understood that the same basic method can be used for combining images from more than two separate image streams. If there are z separate input streams of images, combiner module 35 will have a separate input for each image stream, and an image frame from each stream will be combined with image frames from the other streams to produce a combined image frame of size n×zm, with the image frames disposed one on top of the other in the combined image frame. Where three, four or more separate frames are combined, the frames need not be disposed one on top of the other in a single column as illustrated for two frames in FIG. 2, but may alternatively be positioned in a row, a square array, or the like.

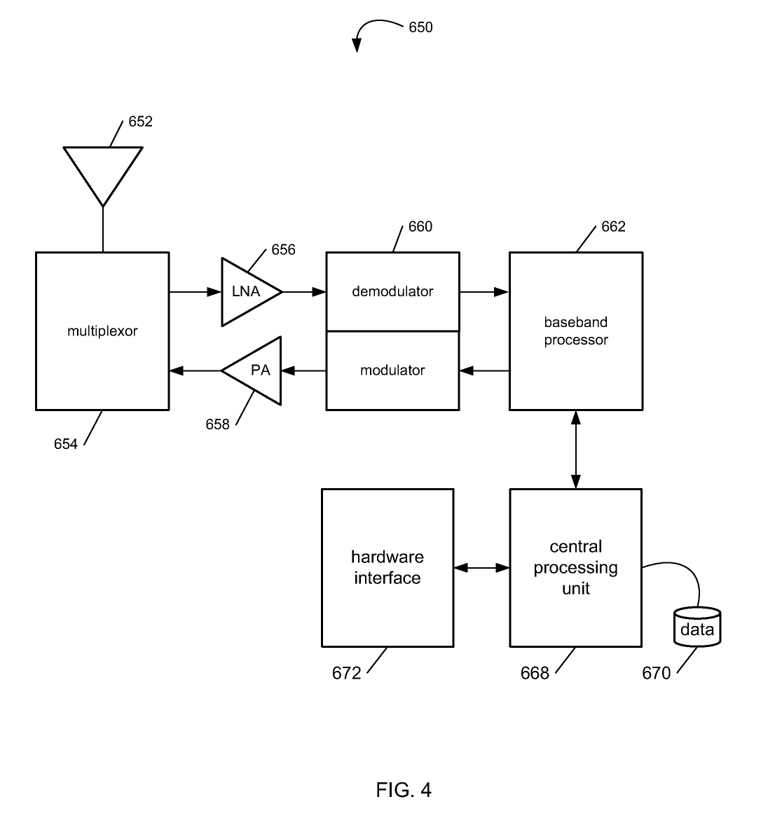

MPEG encoder module 36 will receive the single output stream of successive combined image frames from image combiner module 35 and will use the MPEG standard video compression technique to produce the encoded output stream 21. The output data stream 21 may be provided to a local data processing unit or stored in a local data storage unit for processing or viewing at a later time, or may be transmitted over a network 22 to a receiving station for further processing, as illustrated in FIG. 1. Network 22 may be a wireless, wired, or combination wired and wireless network. Where the network 22 is wireless or partially wireless, any suitable wireless communication device may be used for transmitting the encoded output stream 21 over a wireless network, and a similar wireless communication device may be used at the receiving station for receiving the encoded data stream and passing it to the image decoder and splitter unit 24. One suitable wireless communication device 650 is illustrated by way of example in FIG. 4, and is described in more detail below.

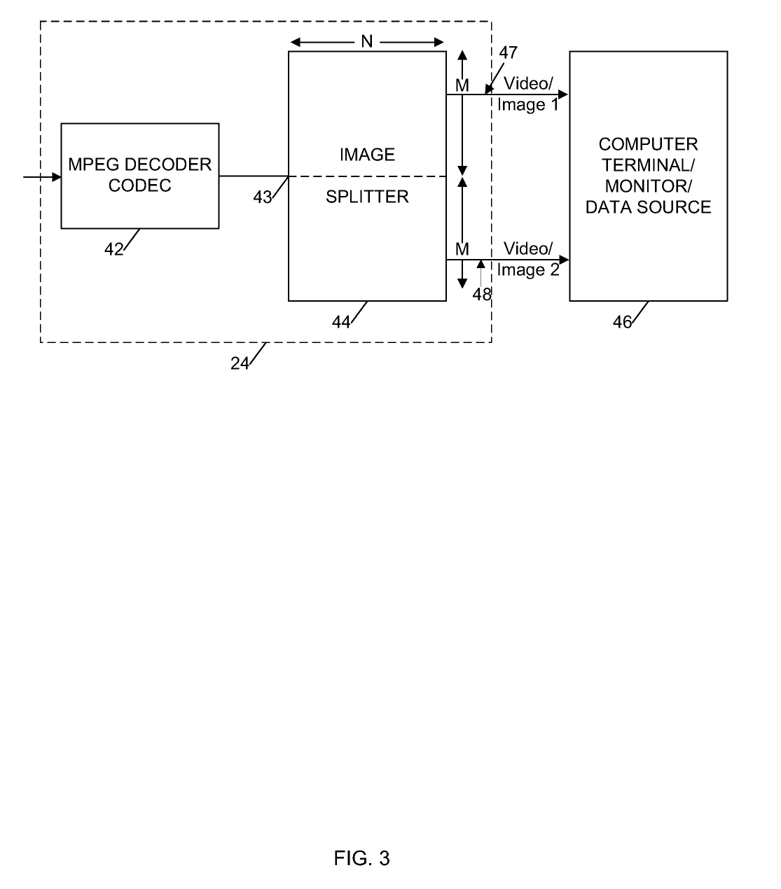

As illustrated in FIG. 3, the image decoder and splitter unit 24 comprises a decoder or codec module 42 and an image splitter module 44. The decoder module will be of the same type as the encoder or codec module 36, for example an MPEG-4 codec. Decoder module 42 will decode the incoming data stream and convert it back into an uncompressed form, and the decoded image stream is then connected to the single input 43 of the image splitter module 44. The decoded image stream will consist of multiple combined image frames of the same format as illustrated in FIG. 2. Where two separate image streams were combined in combiner module 35, each combined frame will have a first portion containing an image I₁ from the first stream and a second portion containing an image I₂ from the second stream. The image splitter module 44 will split the two image portions of each received frame apart to form separate image streams 1 and 2 at outputs 47, 48 which substantially correspond to the original image streams 1 and 2 provided to the image combiner and encoder unit 20. The separate image streams are connected to an output unit 46, which may be a data storage unit for storing the two image streams for later viewing, or a computer or monitor for viewing and processing the image streams together or separately.

It will be understood that image combiner and codec modules of FIG. 2 may be combined in a single housing as indicated in FIG. 2, or may be two separate components. Similarly, the codec and image splitter modules of FIG. 3 may be combined in a single housing or may be separate components.

Although multi-stream MPEG-4 codecs are available, they are cost prohibitive in cameras. The above arrangement allows a less expensive, single stream MPEG-4 encoder to be used for encoding image streams from multiple sources. MPEG-encoding of video uses key frames and difference frames. The video from each source is potentially very different, making it inefficient to send frames from different sources to a codec that supports only one input stream in an interleaved or sequential fashion. Sending single streams from separate sources sequentially through a codec will take more time. Instead, as described above, frames from different sources are located in separate portions of a single combined image frame, which can then be sent to the codec module 36 as if it was a single source of video.

FIG. 4 is a block diagram illustrating an exemplary wireless communication device 650 that may be used in connection with the various embodiments described herein when the network 22 is a wireless or partially wireless network. For example, the wireless communication device 650 may be used in conjunction with an image processing system and method as described above. However, other wireless communication devices and/or architectures may also be used, as will be clear to those skilled in the art, and a wireless communication device will not be used if the network 22 is a wired network.

In the illustrated embodiment, wireless communication device 650 comprises an antenna 652, a multiplexor 654, a low noise amplifier (“LNA”) 656, a power amplifier (“PA”) 658, a modulation circuit 660, and a baseband processor 662. A central processing unit (“CPU”) 668 with a data storage area 670 is connected to the baseband processor 662, and a hardware interface 672 is connected to the baseband processor.

In the wireless communication device 650, radio frequency (“RF”) signals are transmitted and received by antenna 652. Multiplexor 654 acts as a switch, coupling antenna 652 between the transmit and receive signal paths. In the receive path, received RF signals are coupled from a multiplexor 654 to LNA 656. LNA 656 amplifies the received RF signal and couples the amplified signal to a demodulation portion of the modulation circuit 660.

Typically modulation circuit 660 will combine a demodulator and modulator in one integrated circuit (“IC”). The demodulator and modulator can also be separate components. The demodulator strips away the RF carrier signal leaving a base-band receive signal, which is sent from the demodulator output to the base-band processor 662.

The baseband processor 662 also codes digital signals for transmission and generates a baseband transmit signal that is routed to the modulator portion of modulation circuit 660. The modulator mixes the baseband transmit signal with an RF carrier signal generating an RF transmit signal that is routed to the power amplifier 658. The power amplifier 658 amplifies the RF transmit signal and routes it to the multiplexor 654 where the signal is switched to the antenna port for transmission by antenna 652.

At the transmitting end of the system illustrated in FIG. 1, the output of the encoder module 36 will be connected to the baseband processor for processing and transmission via antenna 652. At the receiving end, the output of a baseband processor 662 may be connected to the input of the decoder module 42.

The baseband processor 662 is also communicatively coupled with the central processing unit 668. The central processing unit 668 has access to data storage area 670. The central processing unit 668 is preferably configured to execute instructions (i.e., computer programs or software) that can be stored in the data storage area 670. Computer programs can also be received from the baseband processor 662 and stored in the data storage area 670 or executed upon receipt.

The central processing unit 668 is also preferably configured to receive notifications from the hardware interface 672 when new devices are detected by the hardware interface. Hardware interface 672 can be a combination electromechanical detector with controlling software that communicates with the CPU 668 and interacts with new devices. The hardware interface 672 may be a firewire port, a USB port, a Bluetooth or infrared wireless unit, or any of a variety of wired or wireless access mechanisms. Examples of hardware that may be linked with the device 650 include data storage devices, computing devices, headphones, microphones, and the like.

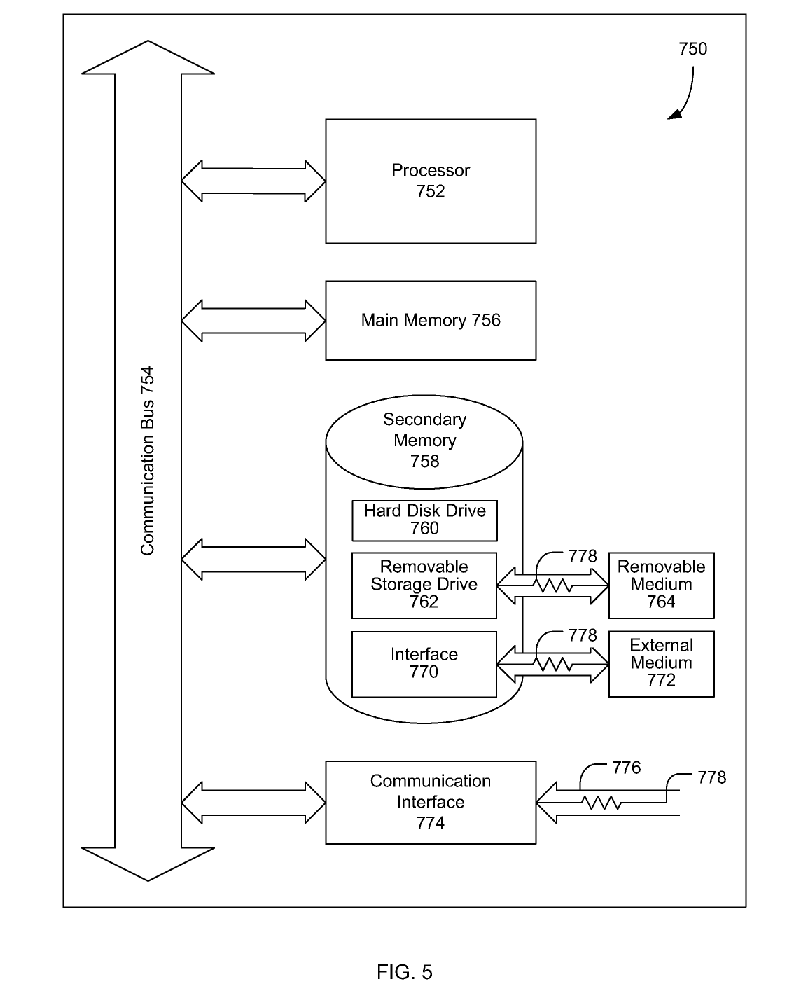

FIG. 5 is a block diagram illustrating an example computer system 750 that may be used in connection with various embodiments described herein. For example, the computer system 750 may control operation of the associated devices, such as the image combiner and encoder and image decoder and splitter of FIGS. 1 to 3, and may further process images received from the decoder and splitter. However, other computer systems and/or architectures may be used, as will be clear to those skilled in the art.

The computer system 750 preferably includes one or more processors, such as processor 752. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 752.

The processor 752 is preferably connected to a communication bus 754. The communication bus 754 may include a data channel for facilitating information transfer between storage and other peripheral components of the computer system 750. The communication bus 754 further may provide a set of signals used for communication with the processor 752, including a data bus, address bus, and control bus (not shown). The communication bus 754 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 750 preferably includes a main memory 756 and may also include a secondary memory 758. The main memory 756 provides storage of instructions and data for programs executing on the processor 752. The main memory 756 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 758 may optionally include a hard disk drive 760 and/or a removable storage drive 762, for example a floppy disk drive, a magnetic tape drive, a compact disc (“CD”) drive, a digital versatile disc (“DVD”) drive, etc. The removable storage drive 762 reads from and/or writes to a removable storage medium 764 in a well-known manner. Removable storage medium 764 may be, for example, a floppy disk, magnetic tape, CD, DVD, etc.

The removable storage medium 764 is preferably a computer readable medium having stored thereon computer executable code (i.e., software) and/or data. The computer software or data stored on the removable storage medium 764 is read into the computer system 750 as electrical communication signals 778.

In alternative embodiments, secondary memory 758 may include other similar means for allowing computer programs or other data or instructions to be loaded into the computer system 750. Such means may include, for example, an external storage medium 772 and an interface 770. Examples of external storage medium 772 may include an external hard disk drive or an external optical drive, or and external magneto-optical drive.

Other examples of secondary memory 758 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 772 and interfaces 770, which allow software and data to be transferred from the removable storage unit 772 to the computer system 750.

Computer system 750 may also include a communication interface 774. The communication interface 774 allows software and data to be transferred between computer system 750 and external devices (e.g. printers), networks, or information sources. For example, computer software or executable code may be transferred to computer system 750 from a network server via communication interface 774 which may be wired or wireless. Examples of communication interface 774 include a modem, a network interface card (“NIC”), a communications port, a Personal Computer Memory Card International Association (“PCMCIA”) slot and card, an infrared interface, and an IEEE 1394 fire-wire, just to name a few.

Communication interface 774 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 774 are generally in the form of electrical communication signals 778. These signals 778 are preferably provided to communication interface 774 via a communication channel 776. Communication channel 776 carries signals 778 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 756 and/or the secondary memory 758. Computer programs can also be received via communication interface 774 and stored in the main memory 756 and/or the secondary memory 758. Such computer programs, when executed, enable the computer system 750 to perform the various functions of the present invention as previously described.

In this description, the term “computer readable medium” is used to refer to any media used to provide computer executable code (e.g., software and computer programs) to the computer system 750. Examples of these media include main memory 756, secondary memory 758 (including hard disk drive 760, removable storage medium 764, and external storage medium 772), and any peripheral device communicatively coupled with communication interface 774 (including a network information server or other network device). These computer readable mediums are means for providing executable code, programming instructions, and software to the computer system 750.

In an embodiment that is implemented using software, the software may be stored on a computer readable medium and loaded into computer system 750 by way of removable storage drive 762, interface 770, or communication interface 774. In such an embodiment, the software is loaded into the computer system 750 in the form of electrical communication signals 778. The software, when executed by the processor 752, preferably causes the processor 752 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Those of skill in the art will appreciate that the various illustrative units, modules and method steps described in connection with the above described figures and the embodiments disclosed herein can often be implemented as electronic hardware, computer software, or combinations of both. To clearly illustrate this interchangeability of hardware and software, various illustrative units, modules and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a unit, module or step is for ease of description. Specific functions or steps can be moved from one module or unit to another without departing from the invention.

Moreover, the various illustrative units, modules and methods described in connection with the embodiments disclosed herein can be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. An image processing method, comprising the steps of:
receiving at least first and second input streams of image frames;
combining an image frame from the first stream with an image frame from the second stream to produce a single output stream of combined frames; and
encoding the single output stream to provide an encoded output stream.

2. The method as claimed in claim 1, wherein each combined frame comprises a frame from said first stream disposed on top of a frame from the second stream.

3. The method as claimed in claim 1, wherein the receiving step comprises receiving more than two input streams of image frames and the combining step comprises combining image frames from each input stream to produce an output stream in which each frame is a combination of one frame from each of the input streams.

4. The method as claimed in claim 1, further comprising the step of transmitting the encoded output stream over a network.

5. The method as claimed in claim 1, wherein each frame of each input stream has a size of n×m, and each combined frame of the output stream has a size of n×zm, where z is the number of separate input streams.

6. The method as claimed in claim 5, further comprising the steps of receiving the encoded output stream, decoding the received stream to produce a decoded stream of frames each having a size of n×zm, and splitting each frame of the decoded stream of frames into z separate frames each having a size of n×m to create z separate streams of images substantially corresponding to the original input streams.

7. The method as claimed in claim 5, wherein z is equal to two.

8. The method as claimed in claim 5, wherein z is greater than two.

9. The method as claimed in claim 1, wherein the encoding step is based on an Moving Picture Experts Group (“MPEG”) standard selected from the group consisting of MPEG-1, MPEG-2, and MPEG-4.

10. The method as claimed in claim 9, wherein the encoding step is based on the MPEG-4 standard.

11. The method as claimed in claim 1, wherein the input streams of image frames comprise outputs from one or more video cameras.

12. The method as claimed in claim 1, wherein the image frame from the first stream and the image frame from the second stream are synchronized in time.

13. The method as claimed in claim 1, wherein the image frame from the first stream and the image frame from the second stream are not synchronized in time.

14. An image processing system, comprising:
a frame combiner module having at least a first input for receiving a first input stream of image frames from a first image source and a second input for receiving a second input stream of image frames from a second image source;
the frame combiner module being configured to combine each frame received at the first input with a frame received at the second input to produce a single output stream of combined image frames at the output; and
an image encoder connected to the output of the frame combiner module configured to encode the single output stream of image frames into an encoded output signal.

15. The system as claimed in claim 14, wherein the frame combiner module is configured to dispose each frame received at the first input on top of each frame received at the second input to produce a combined frame having a height equal to the total height of a frame from the first input stream and a frame from the second input stream.

16. The system as claimed in claim 14, wherein the frame combiner module has only two inputs for receiving two separate streams of image frames.

17. The system as claimed in claim 14, wherein the frame combiner module has more than two inputs for receiving input streams of image frames from a plurality of image sources, and the frame combiner module is configured to combine each frame received at one of the inputs with a frame received at each of the other inputs to produce a single output stream of combined image frames, whereby each combined image frame comprises a frame from each of the input streams.

18. The system as claimed in claim 17, wherein the number of inputs of the frame combiner module is equal to z and each frame of each of the input streams has a size of n×m, and the frame combiner module is configured to combine each successive frame of each of the input streams with a frame from each of the other input streams to produce an output stream of frames each having a size of n×zm.

19. The system as claimed in claim 14, further comprising a receiver for receiving the encoded output signal, a decoder for decoding the received signal and providing a decoded output signal, and an image splitter for splitting each frame of the decoded output signal into two separate frames to create separate streams of image frames substantially corresponding to the first and second input streams of image frames.

20. The system as claimed in claim 14, wherein the encoder is a Moving Picture Experts Group (“MPEG”) standard encoder.

21. The system as claimed in claim 20, wherein the encoder is an MPEG-4 encoder.

22. The system as claimed in claim 14, further comprising at least two image sources connected to the respective inputs of the frame combiner module.

23. The system as claimed in claim 22, wherein the image sources comprise cameras.

24. The system as claimed in claim 22, wherein the cameras comprise video cameras and the streams of image frames comprise video images.

25. The system as claimed in claim 14, wherein the frame combiner module has two inputs.

26. An image processing method, comprising the steps of:
receiving an encoded stream of image frames;
decoding the received stream to produce a decoded stream of combined image frames; and
splitting each frame of the decoded stream into at least two separate frames to create at least first and second separate streams of image frames.

27. The method as claimed in claim 26, wherein each frame of the decoded stream has a size of n×zm, and the splitting step comprises splitting each frame of the decoded stream into z separate frames each having a size of n×m to create z separate streams of images.

28. The method as claimed in claim 27, wherein z is equal to two.

29. The method as claimed in claim 27, wherein z is greater than two.

30. The method as claimed in claim 26, wherein the decoding step is based on a Moving Picture Experts Group (“MPEG”) standard selected from the group consisting of MPEG-1, MPEG-2, and MPEG-4.

31. The method as claimed in claim 30, wherein the decoding step is based on the MPEG-4 standard.

32. The method as claimed in claim 26, wherein the image frames from the first stream and the image frames from the second stream are synchronized in time.

33. The method as claimed in claim 26, wherein the image frames from the first stream and the image frames from the second stream are not synchronized in time.

34. An image processing system, comprising:
a receiver for receiving an encoded signal containing a stream of combined image frames;
a decoder module connected to the receiver and configured to decode the encoded signal to provide a decoded output signal comprising a stream of combined image frames; and
an image splitter module connected to the decoder module configured for splitting each frame of the decoded output signal into at least two separate frames to create separate first and second streams of image frames.

35. The system as claimed in claim 34, wherein the image splitter module is configured to separate a first frame at the top of each combined image frame from a second frame at the bottom of each combined image frame to create the first and second streams of image frames, the first stream comprising a stream of first frames and the second stream comprising a stream of second frames.

36. The system as claimed in claim 34, wherein the frame splitter module has only two outputs for two separate streams of image frames.

37. The system as claimed in claim 34, wherein the frame splitter module has a single input and more than two outputs for providing more than two output streams of image frames corresponding to a plurality of image sources, and the frame splitter module is configured to separate each combined frame received at the input into a plurality of separate image frames, each separated image frame being provided to a respective output of the frame splitter module to produce a plurality of separate output image streams.

38. The system as claimed in claim 37, wherein the number of outputs of the frame splitter module is equal to z and each combined frame of the decoded output signal has a size of n×zm, and the frame splitter module is configured to split each successive frame of the decoded output signal into z separate frames each having a size of n×m, and to provide the separated frames at the respective outputs of the frame splitter module.

39. The system as claimed in claim 34, wherein the decoder module is a Moving Picture Experts Group (“MPEG”) standard decoder.

40. The system as claimed in claim 39, wherein the decoder is an MPEG-4 decoder.

41. The system as claimed in claim 34, wherein the image frames comprise camera image frames.

42. The system as claimed in claim 34, wherein the streams of image frames comprise video image frames.
